(19) United States
(12) Patent Application Publication
(10) Pub. No.: US 2017/0270455 A1
(43) Pub. Date: Sep. 21, 2017

(54) Managing A Workflow Of Human Intelligence Tasks Based On Task Performance

(71) Applicant: Google Inc., Mountain View, CA (US)

(72) Inventors: Ed Huai-Hsin Chi, Palo Alto, CA (US); Peng Dai, Mountain View, CA (US); Praveen Paritosh, Oakland, CA (US); Jeff Rzeszotarski, Chesterland, OH (US)

(73) Assignee: Google Inc., Mountain View, CA (US)

(21) Appl. No.: 14/025,880

(22) Filed: Sep. 13, 2013

(51) Int. Cl. G06Q 10/06

(52) U.S. Cl. CPC G06Q 10/063112

(57) ABSTRACT

Described is a technique for managing a workflow of human intelligence tasks based on task performance. When a large batch of tasks is performed continuously by a worker, task performance may decline. To lessen these consequences and improve overall task performance, the techniques described herein may adjust the type of tasks provided during a workflow. These adjustments may include providing a workflow interruption in the form of a different type of task or a break activity. These interruptions may switch between conceptual and perceptual activities in order to refresh the user and aid in alleviating the negative consequences of repetitive tasks such as physical and cognitive fatigue.

### BACKGROUND

Task marketplaces enable the use of human capital to perform a wide variety of tasks. In one type of marketplace, developers may utilize human intelligence to perform tasks that computers are currently unable to perform. These tasks are often referred to as Human Intelligence Tasks (HITs) and are often distributed within an online crowdsourcing environment. For example, human workers can translate various forms of information, perform recognition tasks, and curate structured data in semantic entity databases. Given suitable motivation, workers may perform large batches of tasks in a single session and completion of tasks in large batches may be beneficial in some circumstances. For example, workers may develop expertise from repeated tasks, and accordingly, diligent workers may support more complex workflows and may ultimately complete more tasks. Providing large batches of tasks, however, may not always be an optimal approach due to the “human” element of workers. For example, high task loads and long hours may introduce negative side effects such as fatigue and boredom. These side effects may affect worker performance, and accordingly, may reduce the overall quality of completed tasks.

### BRIEF SUMMARY

In an implementation, described is a method of providing a workflow of human intelligence tasks. The method may include selecting, from a plurality of stored tasks each of which is associated with a task type, a first task. The first task may be associated with a first task type. The selected first task may be provided to a user. The method may also include determining a workflow attribute of the user based on a performance of the first task and selecting, from the plurality of stored tasks, a second task based on the determined workflow attribute. The second task may be associated with a second task type. The selected second task may be provided to the user. The second task type may include a break activity and the break activity may include at least one of a gaming activity, a lottery activity, a video clip activity, and a comic strip activity. The first task type and the second task type may be selected from a group comprising a cognitive-demanding task and a cognitive-undemanding task. The cognitive-demanding task may include at least one of a translation task, a content rating task, a structured data entry task, a reading comprehension task, and an opinion task. The cognitive-undemanding task may include at least one of an object recognition task, an audio recognition task, a video activity task, a matching task, and a perceptual task. Determining the workflow attribute may include determining a number of tasks performed by the user. In addition, determining the workflow attribute may include determining a cognitive demand score based on tasks performed by the user. The method may also include compensating the user for performing tasks associated with the first task type and not compensating the user for performing tasks associated with the second task type.

In an implementation, described is a method of providing a workflow of human intelligence tasks. The method may include storing a plurality of tasks, a plurality of break activities, and a user history for a user. The user history may include a performance metric for each of the tasks performed by the user. The performance metric may include at least one of a completion time, an engagement metric, an accuracy metric, and a quality metric. The method may include selecting, from the plurality of stored tasks, a first task based on the user history. The selected first task may be provided to the user. The method may include updating the user history based on a performance of the first task, and determining whether to provide a break or a second task to the user based on the updated user history. The method may also include selecting, upon determining to provide the break, a first break activity from the plurality of stored break activities. The selected first break activity may be provided to the user. Each of the stored plurality of tasks may be associated with a task type and the provided first break activity may be based on the task type of the first task. The method may also include determining a likelihood of completing the first task based on the user history and the selected first task may be based on the determined likelihood. In addition, each of the plurality of tasks may associated with a cognitive demand rating, and determining whether to provide the break or the second task may include determining a cognitive demand score.

In an implementation, described is a system for providing a workflow of human intelligence tasks. The system may include one or more storages storing a plurality of tasks and each the plurality of tasks may be associated with a task type. The system may include a processor configured to select, from the plurality of stored tasks, a first task. The first task may be associated with a first task type. The processor may provide the selected first task to a user and determine a workflow attribute of the user based on a performance of the first task. The processor may select, from the plurality of stored tasks, a second task based on the determined workflow attribute and provide the selected second task to the user. The second task may be associated with a second task type. The second task type may include a break activity and the break activity may include at least one of a gaming activity, a lottery activity, a video clip activity, and a comic strip activity. The first task type and the second task type may be selected from a group comprising a cognitive-demanding task and a cognitive-undemanding task. The cognitive-demanding task may include at least one of a translation task, a content rating task, a structured data entry task, a reading comprehension task, and an opinion task. The cognitive-undemanding task may include at least one of an object recognition task, an audio recognition task, a video activity task, a matching task, and a perceptual task. Determining the workflow attribute may include determining a number of tasks performed by the user. In addition, determining the workflow attribute may include determining a cognitive demand score based on tasks performed by the user. The method may also include compensating the user for performing tasks associated with the first task type and not compensating the user for performing tasks associated with the second task type.

In an implementation, described is a system for providing a workflow of human intelligence tasks. The system may include one or more storages storing a plurality of tasks, a plurality of break activities, and a user history for a user. The user history may include a performance metric for each of the tasks performed by the user. The system may include a processor configured to select, from the plurality of stored tasks, a first task based on the user history and may provide the selected first task to the user. The processor may update the user history based on a performance of the first task and determine whether to provide a break or a second task to the user based on the updated user history. The processor may also select, upon determining to provide the break, a first break activity from the plurality of stored break activities and provide the selected first break activity to the user. The processor may also determine a likelihood of completing the first task and the selected first task may be based on the determined likelihood. In addition, each of the plurality of tasks may be associated with a cognitive demand rating. The processor may determine whether to provide the break or the second task based on a cognitive demand score.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a block diagram of a server according to an implementation of the disclosed subject matter.

FIG. 2 shows an example network arrangement according to an implementation of the disclosed subject matter.

FIG. 3 shows a flow diagram of providing a workflow of tasks according to an implementation of the disclosed subject matter.

FIG. 4 shows an example of organizing stored data according to an implementation of the disclosed subject matter.

FIG. 5 shows a flow diagram of providing a break during a workflow according to an implementation of the disclosed subject matter.

### DETAILED DESCRIPTION

Described is a technique for optimizing a workflow of human intelligence tasks based on task performance. When a large batch of tasks is performed continuously by a user, task performance may decline. Users, however, may continue to perform tasks despite reduced performance for various reasons including economics, competitive pressures from peers, insomnia, and other factors including desires to game or “beat” the system. To lessen these consequences and improve overall task performance, described are techniques to adjust the workflow of tasks by altering the type of tasks provided. These adjustments may include providing a workflow interruption in the form of a different type of task or a break activity. These interruptions may refresh the user and aid in alleviating the negative consequences of repetitive tasks such as physical and cognitive fatigue.

Research has shown that breaks can ameliorate boredom and fatigue, but the effects may depend on certain factors. For example, the length of the break may be a factor. Generally, the benefits of a break correspond to the length of the break, but even short (e.g. micro-breaks) that are three to thirty seconds long can have a measurable impact on users. This is encouraging for crowdsourcing markets because micro-breaks have a natural relationship to the scope of tasks and may be slipstreamed into workflows. Another factor is the type of break. For example, a break may be more effective when it differs from repetitive tasks and does not demand an excess of attention resources. One technique of differentiating tasks may involve classifying tasks into cognitive-demanding tasks and cognitive-undemanding tasks. Cognitive-demanding task may include tasks that are conceptual in nature and cognitive-undemanding tasks may include tasks that are more perceptual in nature. Accordingly, when performing a series of conceptual tasks, a cognitive-undemanding task may operate as a cognitive break. This form of relief appears to be an intuitive approach. For example, in a real world analogy, people that are engaged in a highly conceptual task such as studying will often go for a walk or watch TV (tasks which are highly perceptual) in order to take a “mental” break. This approach may also prove beneficial when distributing tasks in a task marketplace. Tasks may be categorized as cognitive-demanding or cognitive-undemanding, or similar categorizations such as conceptual or perceptual. Accordingly, a task workflow may be adapted to provide a different categorization of tasks in order to provide a form of a break.

When generating a user workflow, decision theoretic techniques may be employed for task selection. For example, a server may select tasks based on measured task performance metrics and these metrics may be stored as part of a user history. Accordingly, tasks may be selected based on a user's past performance. Moreover, the user's history may provide a personalized approach, which may be beneficial in a crowdsourced environment where each worker may have different performance characteristics. By monitoring task performance, the allocation of tasks may be adapted in real time. Accordingly, these optimizing techniques may improve overall user performance and task quality.

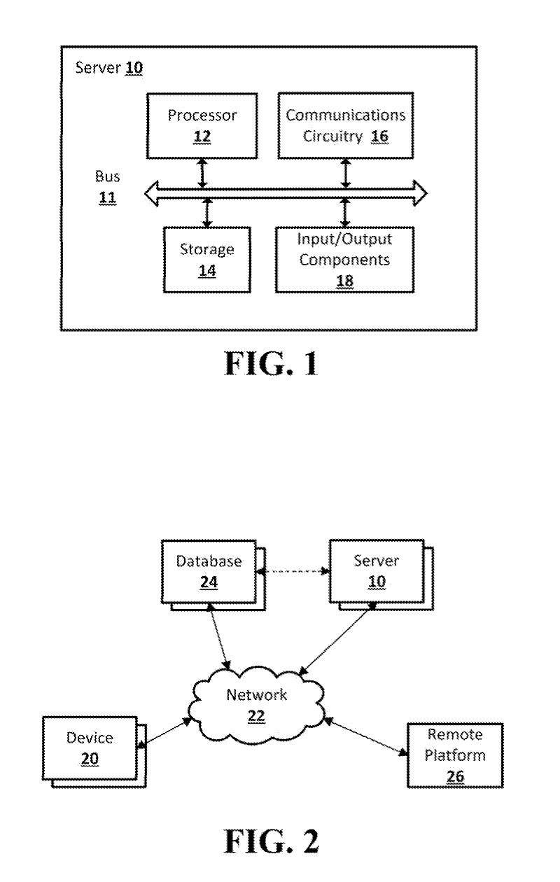

FIG. 1 shows a block diagram of a server according to an implementation of the disclosed subject matter. The server 10 may include a bus 11 which interconnects major components of the server 10, such as a processor 12, a storage 14, communications circuitry 16, and input/output components 18.

The processor 12 may be any suitable programmable control device and may control the operation of one or more processes, such as task management and performance monitoring as discussed herein, as well as other processes performed by the server 10. The storage 14 may be integral with the server 10 or may be separate and accessed through an interface. The storage 14 may store content, software (e.g., for implementing various functions on server 10), and other data. The storage 14 may include any suitable storage medium, such as one or more hard-drives, solid state drives, flash drives, and the like.

The input/output components 18 may include output components and interfaces for a display that provides visual output. The input/output component may also include input components and interfaces for user input devices that allow a user to interact with the server 10. For example, the user input devices may include a keyboard, a keypad, a mouse, touchpad, a touch screen, and the like. The communications circuitry 16 may include one or more interfaces to allow the server 10 to communicate with other servers 10, devices 20, and databases 24 via one or more local, wide-area, or other networks as shown in FIG. 2. In addition, the server may include various high-speed interfaces such as fast Ethernet interfaces, Gigabit Ethernet interfaces, ATM interfaces, HSSI interfaces, POS interfaces, FDDI interfaces and the like. These interfaces may include ports appropriate for communication with the appropriate media, and in some cases, may include an independent processor to control communications intensive functions such as packet switching, task delivery, and task management.

FIG. 2 shows an example network arrangement according to an implementation of the disclosed subject matter. Implementations may include one or more devices 20 which may include or be part of a variety of computing devices such as a personal computer, a handheld device including a mobile phone or “smartphone,” tablet computer, laptop, netbook, desktop, personal digital assistant (“PDA”), media device, set-top box, television, watch, and other devices. The devices 20 may communicate with other devices 20, a server 10, and a database 24 via the network 22. The network 22 may be a local network, wide-area network (including the Internet), and other suitable communications network. The network 22 may be implemented on any suitable platform including wired and wireless technologies.

Server 10 may be directly accessible by one or more devices 20, or one or more other devices 20 may provide intermediary access to a server 10. Devices 20 and server 10 may access a remote platform 26 such as cloud computing arrangement or service. The remote platform 26 may include one or more servers 10 and databases 24. The term server may be used herein and may include a single server or one or more servers. For example, a server 10 may include one or more servers responsible for providing tasks and performance monitoring.

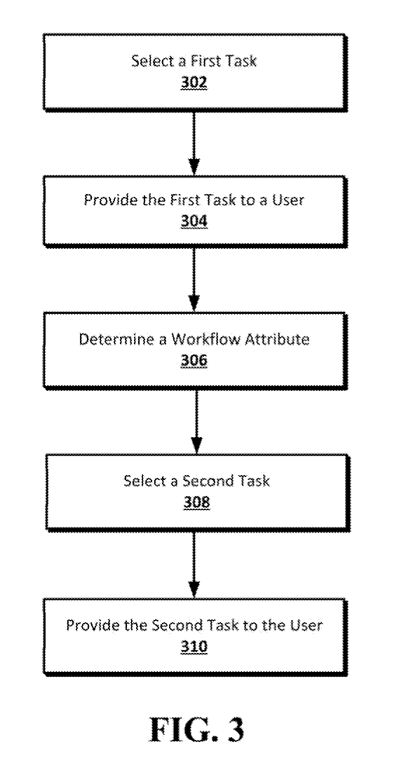

FIG. 3 shows a flow diagram of providing a workflow of tasks according to an implementation of the disclosed subject matter. In 302, a first task may be selected from a plurality of stored tasks. The tasks may include data stored in any suitable storage such as a local storage (e.g. storage 14 or database 24), as part of a task server, or may be stored remotely on additional servers (including additional databases 24), or on a cloud service (e.g. remote platform 26). This data may include task data, user history for one or more users, performance metrics, workflow attributes, and other relevant data.

When selecting a task, a decision theoretic approach may be utilized to improve user performance. The decision theoretic approach may be based on a user history of an individual user or a cluster of users. The user history may include a history of selected task types as well as performance metrics for previously completed tasks. For example, the user history may be analyzed to determine the likelihood that a user will complete a given task. In another example, task categories in which a user has a poor performance history may be minimized when selecting tasks to provide in user's task workflow.

In 304, a selected task may be provided to a user connected to a device 20. A server (e.g. server 10) may distribute tasks to an individual user or to multiple users including users within a crowdsourcing environment. The tasks may be provided in an online setting. For example, this may be accomplished by using a network protocol such as Hypertext Transfer Protocol (HTTP) or other suitable protocols. For instance, a user may connect to a network (such as the Internet) and complete tasks through an interface such as an internet browser or specialized application. A combination of an online setting and offline setting may also be used to provide tasks. For example, a user may download data to perform tasks locally and interact with a server to upload completed portions of a task.

When distributing tasks, a server may distribute multiple tasks or the same task simultaneously. Providing tasks may include initiating an instruction to provide a task to a user. For example, a server may initiate an instruction to a webserver to retrieve a stored task and provide (e.g. serve) the task to a user for completion. Tasks may be provided during a session that includes a workflow of tasks. A workflow of tasks may include a combination of tasks and breaks. A session may begin with a user logging into an account and the session may be terminated by the user affirmatively exiting a session (e.g. logging out). The session may also be terminated automatically based on other criteria. For example, a session may be terminated based on a non-activity duration, non-completion of a task, or a time-out.

In 306, workflow attributes may be determined based on user performance during a workflow of tasks. A server may analyze workflow attributes to determine what types of tasks to provide to a user and when to provide a break to the user. The workflow attributes may include measurable metrics such as a count for the number of tasks completed, a timer, performance metrics, or other attributes or metrics. For example, a server may determine the number of tasks completed by a user and adjust the provided task type or provide a break after a predefined number of tasks have been completed. In another example, the server may adjust the workflow (e.g. determine whether to provide another task or a break) after a fixed amount of time. For instance, a timer may indicate that a break may be provided to the user in 5, 10, or 30 minute intervals. The server may also provide breaks according to a predefined schedule. For example, provide a break after completing five tasks.

The server may also use the workflow attributes to determine performance characteristics that may indicate deteriorating performance by a user. These performance characteristics may be determined based on monitoring or measuring performance metrics. For example, an accuracy or quality metric may indicate that a concentration level may be declining. Similarly, an engagement metric may indicate that a user is becoming bored or uninterested. For example, an engagement metric may be based on a retention rate of the user. If the user's past performance indicates that a user completed a large number of tasks of a certain type, the user will have a high engagement score for that type of task. In other example, a cognitive demand score may be calculated in order to predict when a user's performance may decline due to cognitive requirements of previous tasks. A cognitive demand score may be calculated based on a cognitive demand rating associated with each task as described further herein. During the performance of tasks, a user history including performance metrics may be updated in real-time. Real-time monitoring provides the ability to dynamically determine the workflow. Accordingly, the workflow may be determined based on workflow attributes in the current session or performance metrics of tasks performed in previous sessions.

In 308, a second task may be selected. The second task may be selected based on a determined workflow attribute or another measure of a user's performance. The second task may include a form of break such as a different task type or an actual break activity. For example, it may be determined that a user's engagement level is deteriorating or a cognitive demand score has met a predefined threshold, and thus, a different task type or a break activity may be provided. The different task type or break activity may act as a refresher for the user and thus may improve a user's performance during a workflow of tasks. These breaks may include activities of differing complexity and/or lengths. For example, a break activity may include some form of entertainment activity. In one example, content such as a story or comic strip may be selected. The content may include visual designs and a story that continues across multiple display pages. Accordingly, for each break, the user may receive one page of the comic. By completing more tasks, the user is provided with more of the story. This provides a minimal, but measurably impactful, incentive for a user to complete more tasks. Moreover, the cognitive-undemanding task of reading a comic may provide a cognitive break to, for example, a long conceptually intensive task. In other examples, a break activity may include a gaming activity such as a puzzle, card game, or interactive arcade style game. The break activity may also include a lottery or wagering type activity or content such as a short humorous video or audio clip.

Tasks may be categorized as a break or break activity, or the task may be associated with a break task type. Accordingly, in these situations a server may serve a break activity in the same manner as tasks by simply including these break activities into the user's workflow. In other implementations, break activities may be distinguished from tasks. For example, tasks may be categorized separately from breaks and/or may be stored independently (e.g. segregated break database). In some implementations, breaks may also be distinguished from tasks by classifying breaks as an activity for which the user does not receive compensation. For example, users may be compensated for completing tasks (e.g. paid per task or hourly) and breaks may not be included when calculating a compensation total for a user. For instance, a user may complete a series of tasks in which the user provides a rating for an article. After providing a predefined number of articles, the user may be provided a story to read as a break. In this example, the user may be paid for rating the article (e.g. paid per article), but not the comic strip. Alternatively, in some implementations, a user may also be compensated for completing the break as an additional incentive or bonus.

In 310, the selected break may be provided to the user in a similar manner as the first task as described in 304. After providing a break, another task may be selected as described in 302 and the task may be provided as described in 304, and accordingly, the workflow may be continued. As described above, a decision theoretic approach may be used in selecting an initial set of tasks (e.g. 302) and may be used to determine whether to provide a break or task, and in such instances, determine the type of break or task to provide. Accordingly, one or more decision engines may be used in steps 302, 306, and 308.

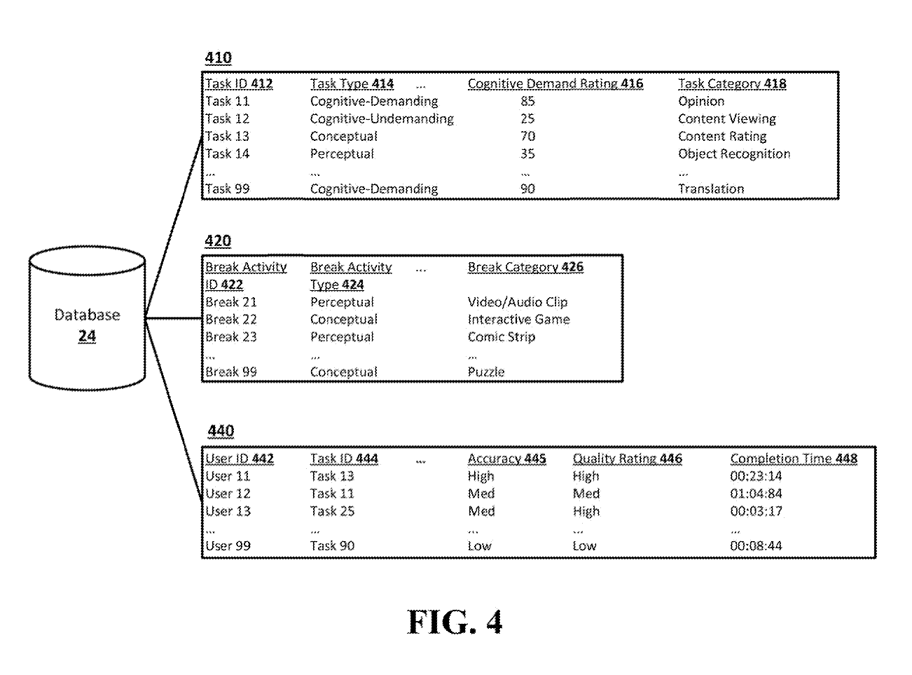

FIG. 4 shows an example of organizing stored data according to an implementation of the disclosed subject matter. As described above with respect to FIG. 3, data may be stored in a storage such as a database 24. This stored data may include task data 410, break activity data 420, and user history data 440. Task data 410 may include tasks and related information. This task data 410 may include a Task ID 412 for identifying a particular task and this task may be associated with a task type 414. The task type 414 may include various forms of categorizing tasks. For example, the task type 414 may include categorizations based on whether the task is a cognitive-demanding or cognitive-undemanding task. In another example, the task type may include categories such as a conceptual task, perceptual task, or other form of task including combinations thereof. As shown in FIG. 4, implementations may include both cognitive-demanding/cognitive-undemanding task types and conceptual/perceptual task types, but other implementations may only include one type of pair. In addition, implementations may not include a task type 414 and may rely solely on the cognitive demand rating 416 (or similar rating) when categorizing tasks.

As shown, the type of task may also be identified by using a rating, weighting, or score. In the example shown in FIG. 4, a task may be associated with a cognitive demand rating 416. For instance, the cognitive demand rating 416 may indicate the degree to which a task may require cognitive effort by a user. For example, a task with cognitive demand rating of 85 (e.g. on a scale between 0-100) indicates that the task is a relatively cognitive intensive task. A lower cognitive demand rating 416, for example, may indicate a task is not as cognitive intensive. These ratings may then be used for weighting or determining whether a particular threshold has been met. For example, if a series of provided tasks have met a predefined threshold or cognitive demand score, it may be determined to provide a cognitive-undemanding task as a break. In another example, a cognitive demand score may anticipate a degree of cognitive exertion by a user. This exertion may be based on the duration of a task along with a cognitive demand rating. For instance, a task that has a relatively high cognitive demand, but can be completed in a short period of time may deplete a user's cognitive resources to a similar extent as a task that is not as cognitive demanding, but requires a longer period of time to complete. Accordingly, various factors such as length of task may also be evaluated when determining when a break may be beneficial. Moreover, the response to a particular cognitive demand score may also be tailored according to each individual user. For example, the user history may indicate that certain users may continue to perform when a certain cognitive demand score is calculated, while other users may benefit from a break at lower cognitive demand scores.

The task data 410 may also include a task category 418, and tasks may be associated with a task category 418. The task category 418 may be used to organize various types of tasks for distribution. For example, the task category 418 may include categories such as an opinion (e.g. opinion on a particular topic), a rating (e.g. rating a written article or content), image recognition (e.g. does a face exist in a particular image), audio recognition (e.g. determining whether a guitar is playing in an audio clip), video recognition (e.g. determining what sports subjects of the clip are playing), video activity, translation, reading comprehension, image tagging, structured data entry, matching, or other task categories. The categories may be associated with particular task types 414. For example, object recognition tasks may be associated with a perceptual task type.

Break activity data 420 may also be stored. The break activity data 420 may include a break ID 422 to identify a particular break and these breaks may be associated with a break activity type 424. In this example, the break activity type 424 may be categorized as a conceptual break or a perceptual break. Breaks may also be associated with a break category 426, and the break category may be used to organize various types of break activities for distribution. For example, the break category 426 may include various types of entertainment such as an interactive game (e.g. puzzle, word game, card game, arcade style game, board game, etc.), lottery or wagering activity, a video/audio clip activity, a story or comic strip type activity, and other forms of entertainment. In the example shown in FIG. 4, the break activity data 420 is organized separately from the task data 410. In other implementations, the break activity data 420 may be stored as task data 410. For example, break activities may be stored as a task (e.g. with a task ID) and may be identified as having a particular task category 418 (e.g. “break” or other identifier as a task category).

User history 440 data may also be stored. The user history 440 may include a history of tasks performed and related performance metrics. In the example shown in FIG. 4, the user history 440 may include a of log of entries including a user ID 442 identifying a user that performed a particular task, which may be identified by a task ID 444. The task ID 444 may correspond to a task ID 412 of the task data. In other implementations, a user history 440 may be organized to include entries for all tasks performed by a particular user (e.g. single user ID), or may include all users that performed a particular task (e.g. single task ID 444, task type, or category, etc.). For example, the user history 440 may be associated to individual users, a cluster of users, or all users.

The user history 440 may also include performance metrics 442. The performance metrics may be used to optimize a user workflow. The performance metrics may include quantitative and qualitative metrics. The qualitative metrics may include metrics related to accuracy 445, quality rating 446, and other metrics such as knowledge level of the user, thoroughness, or other qualitative metrics. The performance metrics may also include quantitative metrics such as completion time 448 and other metrics such as a number of tasks completed, accuracy score, and other quantitative metrics. These metrics may also be task specific. For example, object recognition tasks may include accuracy metrics whereas rating tasks may include more subjective metrics wherein a user's ratings are compared with other users to determine a particular tendency or “taste.” Other suitable techniques in addition to the examples shown in FIG. 4 may also be used to organize data. These techniques may be used in varying types of database configurations such as object oriented databases and/or relational databases.

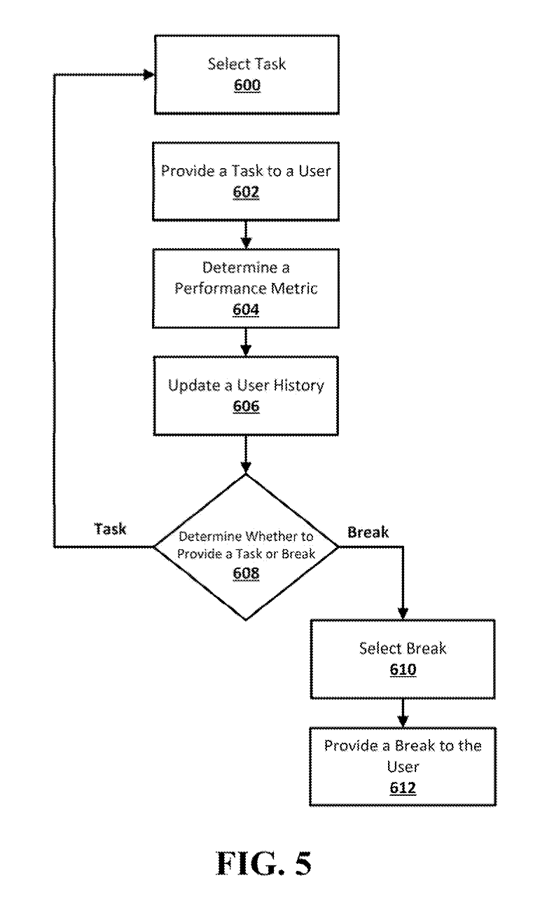

FIG. 5 shows a flow diagram of providing a break during a workflow according to an implementation of the disclosed subject matter. In 600, a task may be selected based on user history 440 data that is associated with the user, and in 602, the selected task may be provided to the user. In 604, a performance metric may be measured during performance of the provided task, and in 606, the user history 440 may be updated based on the measured performance metric. For example, a user's completion time (or average completion time) in the user history 440 may be updated based on a recent task completion time. In another example, a quality rating may be updated based on the quality of a recently completed task. Other performance metrics that are stored in the user history 440 may be also be updated. Based on the user history, a decision whether to provide another task or a break may be made in 608. This decision provides the ability to tailor the workflow of tasks in order to vary the types of tasks and to provide timely breaks. This decision process may be based on various criteria including task types of provided tasks, user history including past performance metrics, workflow attributes and other suitable criteria. For example, task selection may be optimized by varying the type of task type provided to the user. In one instance, this may include providing a particular combination of conceptual tasks and perceptual tasks. In another example, a break may be provided if a particular cognitive demand score or threshold is met. If a decision to provide a break is made, a type of break may be selected in 610. The selection of the break may be based on the user history or a current performance metric. The performance metric may include metrics as described above and may be used to determine the type of break to provide. For example, is a series of conceptual tasks have been performed, the break may include a perceptual type break and vice versa. Once the break is selected, it may be provided to the user in 612. If it is determined to provide another task in 608, a task may be selected in 600 and the process may be repeated. Accordingly, the workflow may be optimized based on task performance.

Various implementations may include or be embodied in the form of computer-implemented process and an apparatus for practicing that process. Implementations may also be embodied in the form of a computer-readable storage containing instructions embodied in non-transitory and/or tangible memory and/or storage, wherein, when the instructions are loaded into and executed by a computer (or processor), the computer becomes an apparatus for practicing implementations of the disclosed subject matter.

The flow diagrams described herein are included as examples. There may be variations to these diagrams or the steps (or operations) described therein without departing from the implementations described herein. For instance, the steps may be performed in parallel, simultaneously, a differing order, or steps may be added, deleted, or modified. Similarly, the block diagrams described herein are included as examples. These configurations are not exhaustive of all the components and there may be variations to these diagrams. Other arrangements and components may be used without departing from the implementations described herein. For instance, components may be added, omitted, and may interact in various ways known to an ordinary person skilled in the art.

References to “one implementation,” “an implementation,” “an example implementation,” and the like, indicate that the implementation described may include a particular feature, structure, or characteristic, but every implementation may not necessarily include the particular step, feature, structure, or characteristic. Moreover, such phrases are not necessarily referring to the same implementation. Further, when a particular step, feature, structure, or characteristic is described in connection with an implementation, such step, feature, structure, or characteristic may be included in other implementations whether or not explicitly described. The term “substantially” may be used herein in association with a claim recitation and may be interpreted as “as nearly as practicable,” “within technical limitations,” and the like.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1-20. (canceled)

21. A computer-implemented method comprising:
providing, by a task management server of a cloud-based, task management and performance monitoring system that includes (i) the task management server, (ii) a task database, and (iii) one or more worker devices, a series of human intelligence tasks to a particular worker device associated with a particular worker within a crowdsourcing environment;
before the particular worker has completed the entire series of human intelligence tasks that were provided to the particular worker device, receiving, by the task management server and from the particular worker device associated with the particular worker within the crowdsourcing environment, data indicating that the particular worker within the crowdsourcing environment has completed a latest human intelligence task of the series of human intelligence tasks;
before the particular worker has completed the entire series of human intelligence tasks that were provided to the particular worker device, determining, by the task management server and based at least on (i) data that characterizes the latest human intelligence task as cognitively demanding or as cognitively undemanding, (ii) a performance metric associated with the particular worker's completion of the latest task, and (iii) the received data indicating that the particular worker within the crowdsourcing environment has completed the latest human intelligence task of the series of human intelligence tasks, that the worker's performance in progressing toward completion of the series of human intelligence tasks within the crowdsourcing environment is likely declining or is likely to decline;
before the particular worker has completed the entire series of human intelligence tasks that were provided to the particular worker device, and in response to determining that the worker's performance in progressing toward completion of the series of human intelligence tasks within the crowdsourcing environment is likely declining or is likely to decline, selecting, by the task management server and from among multiple candidate follow-on human intelligence tasks that are stored in the task database and that are available for distribution to workers within the crowdsourcing environment, a particular follow-on task based at least on (i) a task type associated with the latest task, and (ii) a task type associated with the particular follow-on task; and
before the particular worker has completed the entire series of human intelligence tasks that were provided to the particular worker device, providing, by the task management server and to the particular device associated with the particular worker, the particular follow-on task to the particular worker device as an update to the series of human intelligence tasks.

22. The method of claim 21, wherein a cognitively demanding human intelligence task comprises at least one of a translation task, a content rating task, a structured data entry task, a reading comprehension task, and an opinion task.

23. The method of claim 21, wherein a cognitively undemanding human intelligence task comprises at least one of an object recognition task, an audio recognition task, a video activity task, a matching task, and a perceptual task.

24. The method of claim 21, wherein the multiple candidate follow-on human intelligence tasks comprise a gaming-related task, a lottery-related task, a video clip-related task, and a comic strip-related task.

25. The method of claim 21, comprising:
compensating the worker for performing a cognitively demanding human intelligence task and not compensating the worker for performing a cognitively undemanding human intelligence task.

26. The method of claim 21, wherein selecting the particular follow-on human intelligence task is further based on a number of human intelligence tasks performed by the worker.

27. The method of claim 21, wherein selecting the particular follow-on human intelligence task is further based on a cognitive demand score for the completed human intelligence task.

28. A cloud-based, task management and performance monitoring system comprising:
one or more worker devices;
a task database; and
a task management server and one or more storage devices storing instructions that are operable, when executed by the task management server, to cause the task management server to perform operations comprising:
providing a series of human intelligence tasks to a particular worker device associated with a particular worker within a crowdsourcing environment;
before the particular worker has completed the entire series of human intelligence tasks that were provided to the particular worker device, receiving, from the particular worker device associated with the particular worker within the crowdsourcing environment, data indicating that the particular worker within the crowdsourcing environment has completed a latest human intelligence task of the series of human intelligence tasks;
before the particular worker has completed the entire series of human intelligence tasks that were provided to the particular worker device, determining, based at least on (i) data that characterizes the latest human intelligence task as cognitively demanding or as cognitively undemanding, (ii) a performance metric associated with the particular worker's completion of the latest task, and (iii) the received data indicating that the particular worker within the crowdsourcing environment has completed the latest human intelligence task of the series of human intelligence tasks, that the worker's performance in progressing toward completion of the series of human intelligence tasks within the crowdsourcing environment is likely declining or is likely to decline;
before the particular worker has completed the entire series of human intelligence tasks that were provided to the particular worker device, and in response to determining that the worker's performance in progressing toward completion of the series of human intelligence tasks within the crowdsourcing environment is likely declining or is likely to decline, selecting, from among multiple candidate follow-on human intelligence tasks that are stored in the task database and that are available for distribution to workers within the crowdsourcing environment, a particular follow-on task based at least on (i) a task type associated with the latest task, and (ii) a task type associated with the particular follow-on task; and
before the particular worker has completed the entire series of human intelligence tasks that were provided to the particular worker device, providing, to the particular device associated with the particular worker, the particular follow-on task to the particular worker device as an update to the series of human intelligence tasks.

29. The system of claim 28, wherein a cognitively demanding human intelligence task comprises at least one of a translation task, a content rating task, a structured data entry task, a reading comprehension task, and an opinion task.

30. The system of claim 28, wherein a cognitively undemanding human intelligence task comprises at least one of an object recognition task, an audio recognition task, a video activity task, a matching task, and a perceptual task.

31. The system of claim 28, wherein the multiple candidate follow-on human intelligence tasks comprise a gaming-related task, a lottery-related task, a video clip-related task, and a comic strip-related task.

32. The system of claim 28, wherein the operations further comprise:
compensating the worker for performing a cognitively demanding human intelligence task and not compensating the worker for performing a cognitively undemanding human intelligence task.

33. The system of claim 28, wherein selecting the particular follow-on human intelligence task is further based on a number of human intelligence tasks performed by the worker.

34. The system of claim 28, wherein selecting the particular follow-on human intelligence task is further based on a cognitive demand score for the completed human intelligence task.

35. A non-transitory computer-readable medium storing software comprising instructions executable by one or more computers which, upon such execution, cause the one or more computers to perform operations comprising:
providing, by a task management server of a cloud-based, task management and performance monitoring system that includes (i) the task management server, (ii) a task database, and (iii) one or more worker devices, a series of human intelligence tasks to a particular worker device associated with a particular worker within a crowdsourcing environment
before the particular worker has completed the entire series of human intelligence tasks that were provided to the particular worker device, receiving, by the task management server and from the particular worker device associated with the particular worker within the crowdsourcing environment, data indicating that the particular worker within the crowdsourcing environment has completed a latest human intelligence task of the series of human intelligence tasks;
before the particular worker has completed the entire series of human intelligence tasks that were provided to the particular worker device, determining, by the task management server and based at least on (i) data that characterizes the latest human intelligence task as cognitively demanding or as cognitively undemanding, (ii) a performance metric associated with the particular worker's completion of the latest task, and (iii) the received data indicating that the particular worker within the crowdsourcing environment has completed the latest human intelligence task of the series of human intelligence tasks, that the worker's performance in progressing toward completion of the series of human intelligence tasks within the crowdsourcing environment is likely declining or is likely to decline;
before the particular worker has completed the entire series of human intelligence tasks that were provided to the particular worker device, and in response to determining that the worker's performance in progressing toward completion of the series of human intelligence tasks within the crowdsourcing environment is likely declining or is likely to decline, selecting, by the task management server and from among multiple candidate follow-on human intelligence tasks that are stored in the task database and that are available for distribution to workers within the crowdsourcing environment, a particular follow-on task based at least on (i) a task type associated with the latest task, and (ii) a task type associated with the particular follow-on task; and
before the particular worker has completed the entire series of human intelligence tasks that were provided to the particular worker device, providing, by the task management server and to the particular device associated with the particular worker, the particular follow-on task to the particular worker device as an update to the series of human intelligence tasks.

36. The medium of claim 35, wherein a cognitively demanding human intelligence task comprises at least one of a translation task, a content rating task, a structured data entry task, a reading comprehension task, and an opinion task.

37. The medium of claim 35, wherein a cognitively undemanding human intelligence task comprises at least one of an object recognition task, an audio recognition task, a video activity task, a matching task, and a perceptual task.

38. The medium of claim 35, wherein the multiple candidate follow-on human intelligence tasks comprise a gaming-related task, a lottery-related task, a video clip-related task, and a comic strip-related task.

39. The medium of claim 35, wherein the operations further comprise:
compensating the worker for performing a cognitively demanding human intelligence task and not compensating the worker for performing a cognitively undemanding human intelligence task.

40. The medium of claim 35, wherein selecting the particular follow-on human intelligence task is further based on a number of human intelligence tasks performed by the worker.
